(19) United States
(12) Patent Application Publication
(10) Pub. No.: US 2010/0068792 A1
(43) Pub. Date: Mar. 18, 2010

(54) METHOD FOR THE VOLUME AND BULK REDUCTION OF DOMESTIC WASTE

(75) Inventor: Peter LUTZ, Munich (DE)

Correspondence Address: MORRISON & FOERSTER, LLP, 555 WEST FIFTH STREET, SUITE 3500, LOS ANGELES, CA, 90013-1024, US

(73) Assignee: Bekon Energy Technologies GmbH & Co. KG, Uterfohring (DE)

(21) Appl. No.: 12/561,134

(22) Filed: Sep. 16, 2009

(30) Foreign Application Priority Data
Sep. 16, 2008 (DE) 102008047411.8

(51) Int. Cl. C02F 3/34

(52) U.S. Cl. 435/262

(57) ABSTRACT

A method for the volume and bulk reduction of domestic waste is disclosed, comprising comminution of the domestic waste, separation of the organic fraction of the domestic waste, generation of biogas from the separated organic fraction by anaerobic fermentation along the principal of dry fermentation in a biogas plant, relocation of the organic fraction from the biogas plant into an aerobization container, aerobization and composting of the organic fraction by supplying air, and drying of the composted organic fraction by injection of air.

### FIELD OF INVENTION

Embodiments of the invention relate to a method for the volume and bulk reduction of domestic waste.

### BACKGROUND

So-called “dry fermentation” allows for the methanization of free-flowing biomasses from agriculture, from biological wastes and from communal garden and park areas without transforming the materials into a pumpable, liquid substrate. It is possible to ferment biomasses having a dry substance fraction of up to 50%. This dry fermentation method is disclosed, e.g., in EP 0 934 998 B1.

In “dry fermentation,” the material to be fermented is not stirred into a liquid phase as is the case, e.g., in the liquid fermentation of biological wastes. Instead, the fermentation substrate introduced into the fermenter is permanently kept humid by withdrawing the percolate at the bottom of the fermenter and again spraying it over the biomass. In this way optimum living conditions for the bacteria are achieved. In the recirculation of the percolate it is additionally possible to regulate the temperature, and there is no possibility of adding additives for process optimization.

From WO 02/06439, a bioreactor, or fermenter, having the form of a pre-fabricated garage is known which is operated according to the principle of dry fermentation in the so-called batch process. Following an inoculation with previously fermented material, the fermentation substrate is filled into the fermenter with the aid of wheel loaders. The fermentation container having a garage-type construction is closed by a gas-tight gate. The biomass having the form of garden wastes or replenishable resources is fermented under exclusion of air, with no further blending taking place and no additional material being supplied. The percolate trickling out of the fermentation material is withdrawn via a drainage channel, intermediately stored in a tank, and again sprayed over the fermentation substrate for humidification. The fermentation process takes place in the mesophilic temperature range at 34-37° C.; temperature regulation is effected by means of a floor and wall heating.

The generated biogas is customarily utilized in a block-type thermal power station (BHKW; Blockheizkraftwerk) for the generation of electricity and heat. In order to ensure a constant, sufficient supply of biogas for the block-type thermal power station, several fermentation containers are operated at a temporal offset in the dry fermentation plant. At the end of the residence time, the fermenter volume is emptied completely and then charged anew. The fermented substrate is subsequently supplied to composting, resulting in the formation of an organic fertilizer comparable to conventional composts.

About 50% of domestic wastes are organic constituents. Domestic waste is disposed of either directly by landfilling, by combustion in a waste incineration plant, or by separation of the organic fraction and its biological processing. Biological processing of the organic fraction is differentiated as follows:

Composting with the aim of decomposing the organic fraction (biological section) as completely as possible as well as drying of the material during final maturing and further separation of the remaining material flow into material flows suited for landfilling and further processing. This process consumes energy.

Biogenic drying of the material for further material flow separation and thermal utilization of the dried organic fraction, which is now storable, together with the noxious substances still contained therein. This process equally requires energy but in contrast with composting still contains a large proportion of the native organic material.

Fermentation, dehydration and drying, or drying maturing process, of the fraction high in organic material, separation of the remaining material flows into inert ones suited for landfilling and those suited for thermal utilization (lightweight fraction). This method variant produces its own energy and moreover yields excess energy in the form of biogas.

From DE 38 35 230 C2 a method for producing energy by waste degassing and a waste degassing plant for this purpose are known. In order to reduce the quantity of the waste to be burnt in a waste incineration plant, in accordance with this method the organic fraction from domestic waste is initially separated out and employed for the generation of biogas in a wet fermentation process. Then the degassed waste fractions are dehydrated and dried. As a result of this method, the quantity of the waste having to be burnt is reduced.

From DE 198 33 624 A1a method and a corresponding waste container (bioselect percolator) are known, wherein the domestic waste, or the organic fraction, may remain in one and the same container, and the various options of biological processing may be carried out. A similar method is known from DE 101 25 408 A1.

### DETAILED DESCRIPTION

Starting out from DE 198 33 624 A1 it is the object of the present invention to specify an improved method for the volume and bulk reduction of domestic waste.

This object is achieved through the features of claim 1.

This invention has the effect of combining the generation of biogas and the subsequent composting and drying of the spent organic fraction of the domestic waste. Here, in contrast with the method as known from DE 198 33 624 A1, after the generation of biogas the domestic waste is relocated into an aerobization container. In this way the fermenter may be optimized for the generation of biogas, while the aerobization container may be optimized for composting and subsequent drying of the remaining organic fraction. Due to this separation of biogas generation and subsequent aerobization or composting, the present method may also be integrated into already-existing biogas plants operating along the principle of dry fermentation. Due to this air supply after relocation of the fermentation residue into the aerobization container the quite humid fermentation residue is dried and composting may commence without any further pre-treatment. Due to the triple treatment of the organic fraction of the domestic waste by means of dry fermentation, subsequent composting and subsequent drying of the finished compost, a three-fold volume and bulk reduction of the domestic waste takes place.

Due to the advantageous realization of the invention in accordance with claim 2, liquid is withdrawn from the organic fraction remaining after dry fermentation, and hence the remaining organic fraction may be composted without any further pre-treatment.

Due to preferred embodiment of the invention in accordance with claim 3, drying of the finished compost is accelerated.

Due to the preferred embodiment of the invention in accordance with claim 4, pre-heating of the air for accelerated composting and/or drying of the compost is achieved by the waste heat from a block-type thermal power plant. The utilization of waste heat from the block-type thermal power plant results in a particularly energy-efficient method.

Due to the advantageous realization of the invention in accordance with claim 6, the remaining, non-organic domestic waste fraction is dried by air, additionally resulting in a volume and bulk reduction. This brings about a fourth volume and bulk reduction.

In accordance with the advantageous realization of the invention in accordance with claim 7, the air for drying of the remaining domestic waste fraction is equally pre-heated.

In accordance with the realization in accordance with claim 8, waste heat from the block-type thermal power plant is also utilized for pre-heating air. This results in a particularly energy-efficient process.

Due to the advantageous realization of the invention in accordance with claim 5 or 9, respectively, the air for drying or composting is collected and purified in a bio-filter and only then emitted to the atmosphere. Hereby the introduction of pollutants into the atmosphere is reduced.

In the following an exemplary process sequence shall be described. Initially, in a first step the domestic waste is comminuted and the organic fraction is separated out by sifting or grading. The separated organic fraction of the domestic waste is then utilized in a biogas plant in accordance with the principle of dry fermentation for the generation of biogas. A biogas plant as known from EP 130 158 3 B1 is particularly well suited for this purpose. This represents the first state of volume and bulk reduction of the domestic waste.

After the generation of biogas, the fermentation residue is relocated into an aerobization container and aerobized by feeding air and thus composted. The feed air injected into the fermentation residue from below. Due to this air injection the quite humid fermentation residue is dried and may be composted without any further pre-treatment. This aerobization and composting represents the second stage of the volume and bulk reduction of the domestic waste.

Following the termination of composting, the air supply is maintained and the compost, or the composted organic fraction, is dried by injection of air. This represents the third stage of the volume and bulk reduction of the domestic waste.

The air supplied during aerobization or composting is pre-heated by waste heat from a BHKW (block-type thermal power station). As a result of this pre-heating, the fermentation residue produced by dry fermentation—organic fraction remaining following fermentation—and having a high residual humidity may be composted faster, for the humid fermentation residue is dried quicker by the pre-heated air. The air for drying the finished compost is equally pre-heated by waste heat from the block-type thermal power plant. This accelerates drying of the compost.

The non-organic fraction is also dried with pre-heated air from the block-type thermal power plant, which represents a fourth state of the bulk and volume reduction of the domestic waste.

Drying both of the composted organic fraction and of the non-organic fraction achieves a high chemical and physical stability of the residual waste which may therefore be supplied to landfills. The dried and composted organic fraction may even be used as a landfill liner.

What is claimed is:

1. A method for the volume and bulk reduction of domestic waste, comprising:
(a) comminution of the domestic waste;
(b) separation of the organic fraction of the domestic waste;
(c) generation of biogas from the separated organic fraction by anaerobic fermentation along the principal of dry fermentation in a biogas plant;
(d) relocation of the organic fraction from the biogas plant into an aerobization container;
(e) aerobization and composting of the organic fraction by supplying air, and
(f) drying of the composted organic fraction by injection of air.

2. The method according to claim 1, characterized in that the air supplied in step (e) is pre-heated.

3. The method according to claim 1, characterized in that the air injected in step (f) is pre-heated.

4. The method according to claim 2, characterized in that the biogas produced in step (c) is supplied to a block-type thermal power plant, and in that pre-heating of the air in step (e) and/or step (f) takes place with the aid of waste heat from the block-type thermal power plant.

5. The method according to claim 1, characterized in that the air injected in step (f) for drying the compost is collected and purified in a biofilter prior to its emission to the atmosphere.

6. The method according to claim 1, characterized in that the domestic waste fraction remaining after separation of the organic fraction in step (b) is dried by means of air.

7. The method according to claim 6, characterized in that the air for drying of the remaining domestic waste fraction is pre-heated.

8. The method according to claim 7, characterized in that pre-heating of the air for drying of the remaining domestic waste fraction takes place with the aid of waste heat from the block-type thermal power plant.

9. The method according to claim 6, characterized in that the air for drying of the remaining domestic waste fraction is collected and purified in a bio-filter prior to its emission to the atmosphere.
